(19) United States
(12) Patent Application Publication
(10) Pub. No.: US 2006/0288100 A1
(43) Pub. Date: Dec. 21, 2006

(54) SYSTEM AND METHOD FOR MANAGING INTERNET BASED SPONSORED SEARCH CAMPAIGNS

(76) Inventors: Mark Alan Carson, Elkhorn, NE (US); John Menke Batcher, Lincoln, NE (US)

Correspondence Address: BLACKWELL SANDERS PEPER MARTIN LLP, 720 OLIVE STREET, SUITE 2400, ST. LOUIS, MO, 63101, US

(21) Appl. No.: 11/421,281

(22) Filed: May 31, 2006

Related U.S. Application Data
(60) Provisional application No. 60/595,038, filed on May 31, 2005.

(51) Int. Cl. G06F 15/173

(52) U.S. Cl. 709/224

(57) ABSTRACT

A sponsored search campaign management tool designed to eliminate the gap between search engines and Sponsored Search advertisers by combining website monitoring with Sponsored Search campaigns. Specifically, by combining website monitoring technology with API (Application Program Interface) access to Sponsored Search advertising networks, the present invention is able to provide a conduit for better managing the sponsored search bidding process. If an advertiser's website should become unavailable, the present invention will not just tell the advertiser about it, but protect their Sponsored Search budget by automatically pausing their listings and, equally as important, automatically reactivating their listings once their website recovers.

### CROSS REFERENCE TO RELATED APPLICATION

This application claims the benefit of U.S. provisional application Serial No. 60/595,038, filed May 31, 2005 the disclosure of which is incorporated herein by reference.

### BACKGROUND OF INVENTION

1. Field of Invention

This invention relates generally to internet based sponsored search campaigns and, more particularly, to management of sponsored search campaigns.

2. Background Art

Search engines are computer based tools utilized to locate and access information available over wide area networks (WAN) such as the Internet where users access the search engine with a typical browser interface. Once a user has accessed a given search engine using a browser interface, the user can enter a search term to locate information related to the search term entered. The search engine will typically provide a list of multiple URL links, which provide web pages of information related to the search term entered. Many times the URL link is related to a business's website. A link to a business's website provides an opportunity for a business to market their product or services to a user who is obviously interested due to the nature of the search term entered.

Many businesses saw the growing usage of the Internet as an opportunity to capture the power of the Internet as a means to do commerce, particularly marketing, and began leveraging search engines to drive prospects to their websites. The user of a search engine who has entered a given search term is likely to be a prospective customer. The search engine provides the search results by providing a list of links that the search engine has identified as being related to the search term entered by the user. The list of results are typically provided on one or more web pages, with generally only 10-20 URL link listings to a page. Search engine usage studies have shown that nearly 100% of users will read the top listing, but as little as 20% will read the listing in the number 10 position. A much smaller percentage will bother to go to the next page. Therefore favorable placement of a given link by a search engine could mean the difference between thousands of visitors and no visitors originating from search engines.

Historically, however, to avoid manipulation of the search engines results, owners and operators of search engines gave website operators very little, if any, control over the ranking of websites within their search index. A website operator could build the most comprehensive website on a particular category, but there was no guarantee that their site would be listed on the first page, much less the top three listings. Beginning in 1998, a new Internet advertising technology called “Sponsored Search” has emerged. Sponsored Search enables individual advertisers to control their ranking by bidding for the top positions on specific keywords relevant to their business. For instance, if a company is in the business of selling auto parts, they could “sponsor” the term “auto parts” so that any time “auto parts” was entered as a search term for on a given search engine, their website would be listed at the top.

The cost of sponsoring a given search term is driven by the number of times the search term was entered by various users and the business's/sponsor's link is selected by the user. The advertiser is charged only if the prospect actually “clicked on” (utilized the browser user interface to select a sponsor's link listed usually accomplished by utilizing the mouse user interface to move the cursor over the item to be selected and depressing the select button on a mouse) the sponsor's listing to proceed to their website. However, other competing websites also have the ability to “sponsor” that same term. In cases where there are two or more bidders, the highest bidder is generally ranked first, the second highest bidder second, and so on. Today, with likely over about 500,000 advertisers using Sponsored Search, the marketplace has become very competitive and extremely dynamic—with some keyword rankings changing from minute to minute throughout the course of the day. For example an advertiser may typically bid from $0.10 to $100 for each time their listing is clicked on. The advertiser can also monitor the amount of activity originating from the search engine such that if very little activity is seen originating from the search engine, the advertiser's bid can be adjusted up or down or the Sponsored Search Campaign eliminated completely. There are various methods well known to those skilled in the art for monitoring such activity. If the bid is lowered or the Sponsored Search Campaign is eliminated, it will likely result in a lowering in ranking on the list of results returned by the search engine.

Sponsored Search advertisers can have private access to the back office systems that drive Sponsored Search listings on search engines. By logging into these systems by way of the private access, an advertiser can modify listings and change bids on a keyword-by-keyword basis. In the last four years the concept of Sponsored Search has been adopted by virtually every major search engine through three primary advertising networks, Overture®, Google®, and FindWhat® which provide a large majority of those searches. It has been estimated that the Sponsored Search business is generating nearly $3 billion annually. Sponsored Search has been credited with the fueling of not only the growth of the search engine market, but also the resurgence of the e-commerce model. Some of the primary search engine companies include Google®, MSN®, and some of the primary Sponsored Search companies include Overture®, Google®, and FindWhat®.

Once a user has opted to utilize a search engine to search for information, and has entered a search term, and selected from the list a sponsored search advertiser's link, their website becomes a marketing tool. Websites can have various robust features and graphical presentations that can be accessed and manipulated by the user utilizing a standard browser application. However, regardless of the web-sites marketing capability, the web-site is only effective if it is in fact functioning properly, therefore accessible by the user.

For some companies or advertisers, Sponsored Search has become a vital component to operating their business. Many advertisers such as e-commerce companies rely exclusively on Sponsored Search to provide them with a steady flow of targeted leads, with advertising budgets ranging from a few hundred dollars to tens of thousands of dollars in a given month. However, a gap exists between Sponsored Search listings and the advertiser's website. At the moment that an Internet user clicks on a Sponsored Search listing, the advertiser is charged whatever rate they bid for that given term. If an advertiser's website is unavailable at that same moment, whether it is due to computer hardware, software, or network issues beyond the advertiser's control, the advertiser is charged—but the prospect never makes it to the advertiser's website. Therefore, unnecessary expenditures related to Sponsored Search can occur, as well as lost marketing opportunities. This happens because there is no direct link between the search engine that is displaying the Sponsored Search listings and the website itself. In other words, the search engine does not monitor the health and availability of various websites. Unless directed otherwise, the search engine assumes that when a listing is clicked on the corresponding website is available and open for business. The search engine simply forwards the prospect or user on to the website once the user clicks a link. Because of the standard functionality of web-based navigation (HTTP or Hyper Text Transport Protocol), there is usually not a persistent connection from one website to another. Rather the browsing computer is simply given a new web address (URL) and it makes a new connection to that website.

This gap can be problematic because websites rely on a variety of different technologies in order to function properly. From computer hardware, to software, to local networks, to the Internet backbone itself—all components need to function in complete harmony at the moment that an Internet user visits a given advertiser's site, for example by clicking on an item from a list provided by a search engine. In other words, if one component necessary for web-site operation fails, the web-site can be rendered inaccessible, thus the business/advertiser misses out on marketing opportunities such as those originating from search engines and pays an unnecessary fee with no possible return.

Several website monitoring services have evolved over time to help recognize those instances when website failure has occurred. These services simply initiate a connection to the website from a remote location at some repeating interval. If a connection fails to be made, some type of alert is sent to the advertiser's website operator, usually in the form of an email or page. It's then the responsibility of the advertiser's website operator to take the necessary actions to correct whatever problem caused the website failure. Most website monitoring services also provide some type of reporting to the website operator that allows subscribers to the website monitoring service, access to see website response times, outages, and etc. Some primary website monitoring companies include Keynote®, WebMetrics®, GlobalNetWatch®.

Under the current model, if an advertiser's website was unavailable for an extended period—5 minutes, 15 minutes, overnight, an entire weekend—a sponsored search advertiser would be adversely affected. Depending upon the length of time, the number of keywords bid upon, the rates bid on those keywords, and the number of clicks during the outage, the monetary loss could be substantial. Thus, a costly gap exists in the current way of doing business.

### BRIEF SUMMARY OF INVENTION

The invention is a Sponsored Search Campaign Management Tool (SSCMT) designed to eliminate the gap between Search Engine and Sponsored Search technology and advertiser websites. Specifically, by combining website monitoring technology having API (Application Program Interface) access to Sponsored Search advertising networks, the present invention is able to provide a Sponsored Search advertiser with a conduit for better managing the sponsored search bidding process. If an advertiser's website becomes unavailable, the present invention will not just tell the advertiser about it, but protect their Sponsored Search budget by automatically pausing their listings and, equally as important, automatically reactivating the advertiser's listings once the advertiser's website recovers.

One point of novelty of the present invention lies in the fusion of Website Monitoring technology with Sponsored Search technology thereby creating the present SSCMT invention. Various services have been built to optimize Sponsored Search listings. Most of these services function at the keyword or keyphrase level and don't incorporate automated deactivation or reactivation of the search campaigns triggered by website events such as site outages or recovery. Also, to our knowledge, monitoring and campaign management services have never been fused into a single, functional piece of technology.

One embodiment of the present invention comprises web-site monitoring functionality and campaign management functionality having automated features for modifying campaigns and insuring the advertiser against potential losses during website outages. Points of novelty unique to the present invention are:

1. the fusion of monitoring and campaign management in one, single application.

2. the automation of sponsored search management at the campaign or account level.

3. the ability to automatically pause sponsored search campaigns when website outages are detected.

4. the ability to automatically resume sponsored search campaigns when website recovery is detected.

5. the ability to automatically alert the appropriate personnel contacts during the pause or resume phases.

These and other advantageous features of the present invention will be in part apparent and in part discussed below.

### BRIEF DESCRIPTION OF THE DRAWINGS

For a better understanding of the present invention, reference may be made to the accompanying drawings in which:

FIG. 1 is a functional block diagram illustrating the system of the present invention;

FIG. 2 is a functional flow diagram illustrating the method of the present invention; and

FIG. 3 is a screen shot illustrative of a list of search results provided by a search engine.

### DETAILED DESCRIPTION OF INVENTION

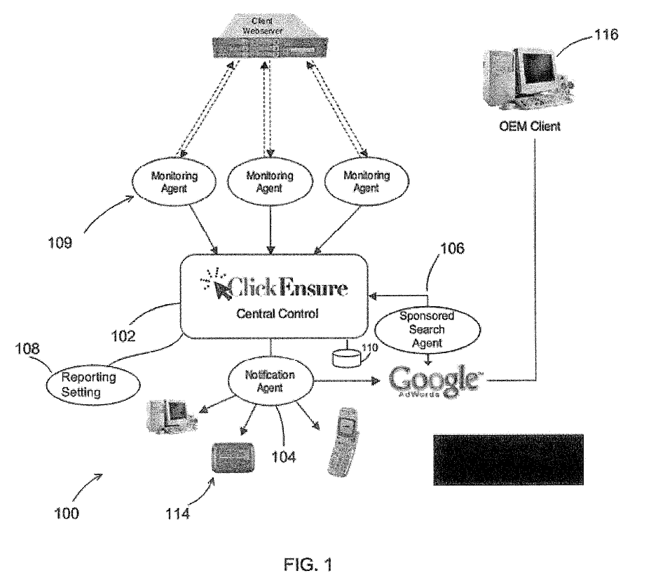

According to the embodiment(s) of the present invention, various views and/or illustrations are presented in FIG. 1-3 and like reference numerals are being used consistently throughout to refer to like and corresponding parts of the invention for all of the various views and figures of the drawing. Also, please note that the first digit(s) of the reference number for a given item or part of the invention corresponds to the Fig. number in which the item or part is first identified.

One embodiment of the present invention comprising web-site monitoring functionality and campaign management functionality having automated features for modifying campaigns and allowing the advertiser to avoid potential losses during website outages, teaches a novel system and method for managing Sponsored Search campaigns. The Sponsored Search Campaign Management Tool (SSCMT) can utilize three pieces of information in its function, including the URL of the advertiser's website that is to be monitored such that monitoring can be performed, the campaign ID for each Sponsored Search advertising network that relates to this particular website, and Contact information for individuals responsible for the advertiser's website and Sponsored Search campaigns. This contact information can generally include an email address, pager number, or SMS address.

The method of the present campaign management invention can include the following steps:

1. monitoring an advertiser's website by initiating an HTTP connection with the site's server at some repeating interval (for example from approximately about 60 seconds to about 60 minutes).

2. storing connection information in a central database of the SSCMT and allowing the Central Control of the SSCMT to access the stored connection information and analyzing of the connection data within the Central Control.

3. If the stored information indicates that the connection is made successfully, no additional action is taken by the Central Control.

4. If the stored information indicates that the connection to the website failed, a series of automated actions are initiated by the Central Control:

a. If the connection failure indication is the first failure in a series:
i. An alert can be sent to all associated contacts informing them that the advertiser's website is not responding and that Advertiser's Sponsored Search listings will be paused if a failure is detected on the next check.

b. If the connection failure indication is the Second Failure in a series:
i. The Central Control system makes a connection to each Sponsored Search advertising network issuing a “pause” command for the campaign in question.
ii. An alert can be sent to all associated contacts informing them that advertiser's website is not responding and that advertiser's Sponsored Search listings have been paused.

c. If the failure continues:
i. An alert is sent by the Central Control to all associated contacts informing them that the advertiser's website is not responding and that their Sponsored Search listings remain paused.

5. If a connection is made successfully following a failure, a series of automated actions are initiated by the Central Control:

a. The Central Control makes a connection to each Sponsored Search advertising network and issues a “resume” command for the campaign in question.

b. An alert is sent to all associated contacts informing them that advertiser's website has recovered and that their Sponsored Search listings have been reactivated.

6. At any time, an advertiser who is a subscriber may login to the SSCMT system in order to access a variety of information related to their website including:

Connection results

HTTP status code

Explanation of status code

Connection time

Alert status

Sponsored Search campaign status

Connection time trends as raw data or graphs

Isolation of error sequences

The details of the invention and various embodiments can be better understood by referring to the figures of the drawing. Referring to FIG. 1, a system functional diagram 100 is shown, which reflects the top level functional components of the Sponsored Search Campaign Management Tool (SSCMT). The system includes a Central Control 102, which functions as the central repository for all data and logic for present management tool. There are various functional sub-components that reside within Central Control such as the Notification Agent 104 sub component, the Sponsored Search Agent 106 sub component, the Reporting Settings 108 sub component, The Monitoring Agent 109 sub component and the database sub 110 component.

The Notification Agent 104 sub component can be the system that notifies advertiser client contacts of important events related to the advertiser's website availability. The advertiser client contact could be, for example, an individual designated by the advertiser as one who is to be contacted in case of a significant event such as an incident where a advertiser web-site can not be accessed. For example, when Central Control detects that a failure has occurred with the advertiser's website, it issues a command to the Notification Agent initiating the Notification Agent to contact a designated advertiser client contact. Based on the Advertiser subscriber settings and the number of contacts that the Advertiser enter, the Notification Agent can send alerts to the designated advertiser client contacts via email, pager, Instant Message, or cell phone SMS generally designated as 114. The Notification Agent sends several pieces of important information related to the website availability including: the time of the activity, the current status of website, the status code including explanation, and any actions being taken on their Sponsored Search campaigns.

As discussed above, the advertiser can also monitor the amount of activity originating from the search engine or the Sponsored Search Advertising Network that if very little activity is seen originating from the search engine, the advertiser's bid can be lowered or the Sponsored Search Campaign eliminated all together. There are various methods well known to those skilled in the art for monitoring such activity. If the bid is lowered or the Sponsored Search Campaign is eliminated, it will likely result in a lowering of the advertiser's website link in ranking on the list of results returned by the search engine. Similarly, with the present invention, if the monitoring agent detects the website is down and the campaign can be eliminated or paused then the ranking may be lowered by the search engine.

As discussed above, Sponsored Search advertisers can have private access to the back office systems of the Sponsored Search Advertising Network that drive Sponsored Search listings on search engines. Access is allowed by way of a Campaign ID. By logging into these systems, an advertiser can modify listings and change bids on a keyword-by-keyword basis. The Sponsored Search Agent 106 sub-component of SSCMT can be a system that automatically issues commands to the various Sponsored Search advertising networks on behalf of the advertiser when certain conditions occur. If Central Control detects that a failure has occurred on two consecutive checks, it issues a command to the Sponsored Search Agent, which in turn issues a command to the respective Sponsored Search advertising networks to “pause” the campaigns for the advertiser in question. Once a “pause” command is issued, the advertisers' Sponsored Listings will generally disappear from the search engines within a few seconds.

The Reporting and Settings 108 component provides the display of data and events associated with monitoring an advertiser's website. Each advertiser client has the option of accessing all the data collected that is related to their website availability including: connection data of each and every interval check, and actions taken at each interval, connection time trends as raw data or graphs, and isolation of error sequences. Reporting provides not only tangible evidence of the checks being performed, but also allows advertiser website operators the ability to analyze the error sequence, and marketers the ability to calculate averted losses as a result of using the management tool.

This component also obtains the appropriate Settings or core information required to establish an account for the present SSCMT system. To subscribe to the SSCMT service system, three different pieces of information can be required: the URL of the advertiser's website to be monitored, the search engine provider's Sponsored Search Advertising Network account id's associated with the Advertiser's website, and who to contact in the event of an outage. This information can be required before an account is created, but it can be modified after the fact by logging into the SSCMT administrative interface.

The Monitoring Agents 109 sub components are the front-line systems that initiate connections to advertiser client websites. In order to maintain reliable monitoring of websites, originating connections can be made from a remote location, preferably from several remote locations on different Internet backbones. For instance, if a website hosted in a datacenter in Sunnyvale, Calif. is being monitored from within the same datacenter, it may detect problems with the webserver itself, but does not take into consideration the many factors that may occur outside the datacenter. Similarly, if an advertiser's website hosted in California is being monitored from Washington State, it may not pick up an outage affecting the East coast. As a result of these considerations, the Sponsored Search Campaign Management Tool can comprise many independent, geographically dispersed monitoring agents. These agents can be thought of as automated robots, making connections to a website at predefined intervals, and relaying the results back to Central Control. The agents do not react to events themselves, but rather forward the connection data on to Central Control where it can make decisions based on the collective information from all agents. For example the management tool can offer monitoring agents on multiple Internet backbones in multiple locations throughout the U.S. including, but not limited to, New York, Florida, Chicago, Dallas, Seattle, Los Angeles, and San Francisco. Additional monitoring locations and networks can be added as needed.

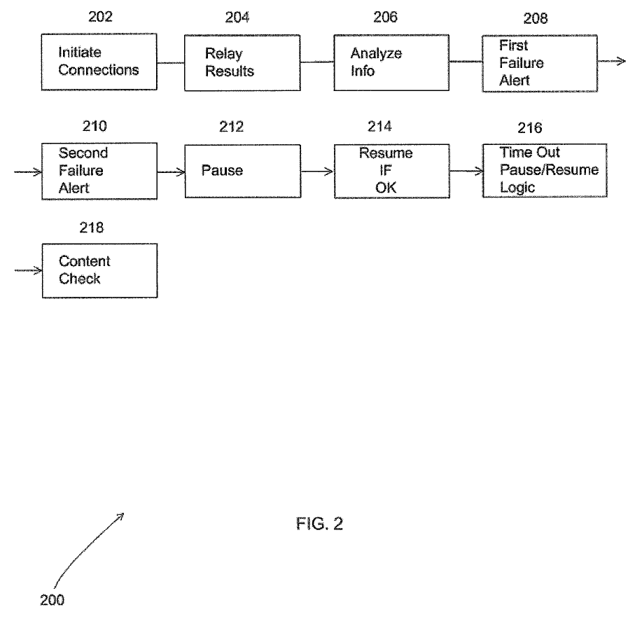

Referring to FIG. 2, a functional flow diagram 200 illustrating the method of the present Sponsored Search Campaign management tool invention is shown. The functional logic flow outlines the decision process used to evaluate what actions can be taken during certain situations. The flow diagram provides an over view of the SSCMT logic.

The flow is initiated by one or more monitoring agents initiating connections 202 to the client's or advertiser's website at predefined intervals, and relaying 204 the results back to Central Control. Central Control receives the relayed results and can make decisions 206 based on the collective information from all monitoring agents. The Central Control can assess the collective information and determine whether a Website Failure indication will be rendered. The Central Control contains logic to determine whether localized events have occurred to cause individual Monitoring Agents to detect a website failure, or whether a majority of the agents have failed. The Central Control logic can be designed such that a majority of the monitoring agents must indicate a website failure condition for the advertiser's website to be deemed unavailable. For example, if three Monitoring Agents are being utilized, the logic can be designed such that one out of three will not warrant action, but two out of three will.

Further the Central Control logic can be designed such that if a First Failure is detected (as defined previously) at a given interval, alerts can be sent 208 by Central Control to all contacts associated with the advertiser's SSCMT subscriber account. However the logic of the Central Control can be designed such that Sponsored Search listings provided on a Sponsored Search Advertising Network are NOT paused upon determination of a First Failure. This allows a client website operator the opportunity to correct any immediate issues.

Further the Central Control logic can be designed such that if a Second Failure is detected on two consecutive intervals, alerts are sent 210 to all contacts associated with the client's account AND the associated Sponsored Search listings can be paused. As indicated above, clients or Sponsored Search advertisers can have private access to the back office systems of the Sponsored Search Advertising Network that drive Sponsored Search listings generated by search engines. By utilizing an advertiser's campaign ID to log into these systems, an advertiser can modify listings and change bids on a keyword-by-keyword basis. The operator of the Sponsored Search Campaign Maintenance Tool can be allowed access on behalf of the client by way of the campaign account ID. If Central Control detects that a failure has occurred on two consecutive connection attempts, Central Control can issue a command to the Sponsored Search Agent component, which in turn issues a command to the respective Sponsored Search advertising networks to “pause” the campaigns for the advertiser in question. Once a “pause” command 212 is issued, the advertiser's Sponsored Listings will generally disappear from the search engines within a few seconds.

If failures continue to be detected by Central Control, then alerts can continue to be sent indicating the length of time the outage has extended. Optionally, escalation procedures can be triggered sending alert notifications to additional personnel. For instance, the escalation procedure could provide that if the outage exceeds 30 minutes, central control will contact the IT manager. And that if the outage exceeds 60 minutes, central control will contact the IT director and marketing director.

Central Control can also contain logic to detect Website Recovery similar to the logic used to detect a website failure. For example, central control could provide that a majority of Monitoring Agents must connect successfully for the website to be deemed available. If the recovery condition is met, recovery alerts are sent to all contacts associated with the client account and the associated Sponsored Search listings are reactivated by issuing a command to the Sponsored Search Agent, which in turn issues a command to the respective Sponsored Search advertising networks to “resume” the campaigns for the advertiser in question. Once a “resume” command 214 is issued, the advertiser's Sponsored Listings will generally reappear on the search engines within a few seconds. Notification of the recovery will be sent from Central Control to the designated contact.

Central Control can also contain logic to detect Timeouts where in some instances, an advertiser's website may still be technically responding, but is just taking too long to make a connection indicating some type of website problem is occurring. If the connection time exceeds some defined threshold, for example 60 seconds, the website will be deemed unavailable and a similar “pause” and “resume” sequence 216 can be followed.

The Central Control can also contain logic to perform Content Checks 218, which may be necessary because some webserver software can have the potential to provide “false positives” to a monitoring agent. For instance, common website errors result from failure of the web application server software such as ASP, PHP, or ColdFusion. In this scenario, the website can be rendered useless, however, the webserver may still be returning back a response like “Server Error”, which may indicate the server encountered an internal error and was unable to complete a request. Therefore, if the Central Control did not contain the appropriate logic, by default, if a connection was made and the webserver responded, it would falsely assume that the website is available. To avert this problem, “Content Checks” can be defined in the Central Control to look for specific text strings in the response. For example, if the text string “ABC Auto Parts” is in the monitored web page, that text string must be present in the response. If it is not, the website will be deemed unavailable and a similar “pause” and “resume” sequence would be followed.

The present invention can also be configured to perform checks on multiple pages/URLs within a website. Due to the configuration of some websites, a website may really be served by many different back-end web servers (i.e. one for content, one for shopping cart, one for secure connections, etc.). To accommodate more complex websites, a subscriber of this service may elect to create multiple checks on multiple URL's on their website, providing an additional level of protection if one server is functional, and another is not. If failures are detected on any server, the same predefined rules would be engaged to perform notifications and/or pausing of the sponsored search campaign.

Some of the same problems that the Monitoring Agents are designed to monitor for clients websites can affect its own operation. Therefore the present SSCMT system can have redundant systems in place to be able to continue servicing clients even when system failures occur. Therefore, redundant Monitoring Agents and Central Controls can be put in place.

The present Sponsored Search Campaign Management Tool invention overlaps with several different aspects of the Internet. As such, the present invention can be engineered in a fashion that it can be operated and marketed direct or in an OEM format that can be leveraged with a variety of partners. OEM, which is an acronym for Original Equipment Manufacturer, is a term usually used to refer to a product or service which is incorporated and marketed as another companies' product or service. The most likely interested partners would be found in the following markets: Search Engines, Sponsored Search Advertising Networks, Monitoring Services, and Sponsored Search Service Providers. For example, Google, a Sponsored Search ad network, already has sponsored search customers. Therefore, this invention could be marketed as an additional add-on service to Google's existing service offering. Likewise, Keynote, a website monitoring service, already has monitoring customers. Therefore, this invention could be marketed as an additional add-on service to Keynote's existing service offering. The OEM, see item 116 of FIG. 1 format would allow these partners to offer the management tool services as their own branded product, leveraging their existing relationships with their own customer base. This invention could be licensed exclusively to a single service provider, or it could be licensed to multiple companies in different fields. Additionally, the licensee may choose to simply access this inventions technology remotely through defined API's, or they may elect to host the hardware and software themselves.

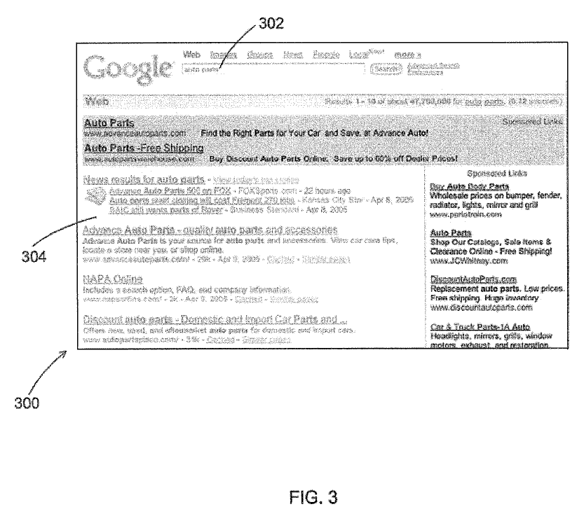

Referring to FIG. 3, a screen shot 300 illustrative of a list of search results provided by a search engine is shown. The screen shot is illustrative of an example where the user has entered “auto parts” as a search term 302. The search engine has returned a list of links 304 for the user to choose from. If the user clicks on one of the links, then the user's browser interface navigates to the selected link. It is evident that only a certain number of listings can appear on the first page of the search result. A typical user may never make it past the first few listings and likely will never make it to a second page of listing. Thus, being at the top of the list on the first page may provide a marketing advantage.

One embodiment of the present invention is a web-site monitoring and sponsored search campaign management tool system having automated features for modifying campaigns and avoiding potential losses during website outages. The search campaign management tool system can include a central control function that communicates with and manages various sub functions including a sponsored search agent function, a notification agent function and a monitoring agent function. The central control function and the sponsored search agent function and the notification agent function can be a server application in a local area network. The central control function can communicate with the monitoring agent function over a wide area network such as for example the internet. Therefore the search campaign management tool system can be a combination of a local area network and a wide are network. The tool can also include a reporting setting, which can be defined by the OEM client.

The web site monitoring agent function is an integral part of the sponsored search campaign management tool where the web site monitoring agent has functionality to detect a web site outage and to send a web site outage notification to the sponsored search campaign management tool, specifically the central control function, if the web site outage is detected. The monitoring agent function can initiate a connection to a web site URL and if the connection is established by launching or reporting back of the web site then it can be determined that an outage has not occurred. The campaign management tool can also examine the content of what is reported back from the web site to assure that what is reported back is not merely an error message. If the connection cannot be established then an outage notification can be transmitted by the monitoring agent. The tool can be designed such that several attempts are made to connect before an outage notification is deemed appropriate.

The search campaign management tool can have the functionality to receive and interpret the web site outage notification and initiate a pause phase function pausing sponsored search campaigns when website outage notifications are received. This can be accomplished by the central control function receiving and processing the outage notification and then transmitting a pause command to the sponsored search agent function. The search campaign management tool can have the functionality to automatically perform the function of resuming sponsored search campaigns when website recovery is detected by the monitoring agent function. The resume campaign phase can be initiated when the connection can be established again. The search campaign management tool can have the functionality to automatically alert an appropriate personnel contact during the pause or resume phases. The method of alerting such as by mobile phone, Email, or pager can be defined by the OEM.

The function of detecting web site outages is performed by the monitoring agent initiating an HTTP connection with the web site's server at some repeating interval and monitoring response. The function of alerting the appropriate contact is performed by a notification agent function having designated client contact settings predefining the personnel contact and the method of contact.

The above system embodiment can perform a method implemented in software and/or hardware for monitoring and managing a sponsored search campaign. A method can be performed including the step of monitoring a client web site and detecting any web site outages utilizing a monitoring agent function; and sending a web site outage notification to a sponsored search campaign management tool if a web site outage is detected. A further step can be receiving and interpreting the web site outage notification with the sponsored search campaign management tool and initiating a pause phase function pausing sponsored search campaigns with the management tool when website outage notifications are received.

Resuming sponsored search campaigns with the search campaign management tool is another step that can be performed when website recovery is detected by the monitoring agent function. The step of automatically alerting an appropriate personnel contact when the pausing or resuming sponsored search campaigns can also be performed.

The method can also be such that the function of detecting web site outages can be performed by the monitoring agent initiating an HTTP connection with a web site's server at some repeating interval and determining if the connection is established. Also, the function of alerting the appropriate contact can be performed by a notification agent function having designated client contact settings predefining the personnel contact and the method of contact. The search campaign management tool can include a search engine activity detection function which is operable to vary a campaign bid based on search engine activity for certain key words.

The various Sponsored Search Management Tool examples shown above illustrate a novel method of managing Sponsored Search Campaigns. A user of the present invention may choose any of the above embodiments, or an equivalent thereof, depending upon the desired application. In this regard, it is recognized that various forms of the subject Sponsored Search Campaign Management Tool could be utilized without departing from the spirit and scope of the present invention. As is evident from the foregoing description, certain aspects of the present invention are not limited by the particular details of the examples illustrated herein, and it is therefore contemplated that other modifications and applications, or equivalents thereof, will occur to those skilled in the art. It is accordingly intended that the claims will cover all such modifications and applications that do not depart from the spirit and scope of the present invention. Other aspects, objects and advantages of the present invention can be obtained from a study of the drawings, the disclosure and the appended claims.

What is claimed is:

1. A web-site monitoring and sponsored search campaign management tool system having automated features for modifying campaigns and avoiding potential losses during website outages comprising:
an integral web site monitoring agent function and sponsored search campaign management tool where said web site monitoring agent has functionality to detect a web site outage and to send a web site outage notification to the sponsored search campaign management tool if the web site outage is detected;
said search campaign management tool has functionality to receive and interpret the web site outage notification and initiate a pause phase function pausing sponsored search campaigns when website outage notifications are received;
said search campaign management tool having the functionality to automatically perform the function of resuming sponsored search campaigns when website recovery is detected by the monitoring agent function; and
said search campaign management tool having the functionality to automatically alert an appropriate personnel contact during the pause or resume phases.

2. The system as recited in claim 1, where the function of detecting web site outages is performed by the monitoring agent initiating an HTTP connection with the web site's server at some repeating interval and monitoring response.

3. The system as recited in claim 2, where the function of alerting the appropriate contact is performed by a notification agent function having designated client contact settings predefining the personnel contact and the method of contact.

4. The system as recited in claim 3, where the functions of initiating a pause phase function pausing sponsored search campaigns when website outage notifications are received and of performing the function of resuming sponsored search campaigns when website recovery is detected are performed by a sponsored search agent function which is communicably linked to send pause commands or resume commands to multiple advertising networks.

5. The system as recited in claim 4, where the monitoring agent function comprises multiple monitoring agent functions each remotely located on different internet backbones and where each of the multiple monitoring agent's originating connection initiating an HTTP connection with the web site's server is made from the remote location and where each sends a separate web site outage notification to the search campaign management tool when detecting an outage.

6. The system as recited in claim 5, where the search campaign management tool has control logic initiating a pause phase function pausing sponsored search campaigns when website outage notifications are received by multiple monitoring agent functions.

7. The system as recited in claim 6, where the search campaign management tool and the monitoring agent performs a content check on the response back from the web sites server when the HTTP connection is initiated.

8. A method for monitoring and managing a sponsored search campaign comprising the steps of:
monitoring a client web site and detecting any web site outages utilizing a monitoring agent function;
sending a web site outage notification to a sponsored search campaign management tool if a web site outage is detected;
receiving and interpreting the web site outage notification with the sponsored search campaign management tool and initiating a pause phase function pausing sponsored search campaigns with the management tool when website outage notifications are received;
resuming sponsored search campaigns with the search campaign management tool when website recovery is detected by the monitoring agent function; and
automatically alerting an appropriate personnel contact when pausing or resuming sponsored search campaigns.

9. The method as recited in claim 8, where the function of detecting web site outages is performed by the monitoring agent initiating an HTTP connection with a web site's server at some repeating interval and determining if the connection is established.

10. The method as recited in claim 9, where the function of alerting the appropriate contact is performed by a notification agent function having designated client contact settings predefining the personnel contact and the method of contact.

11. The method as recited in claim 10, where the function of initiating a pause phase function pausing sponsored search campaigns when website outage notifications are received and where the function of performing the function of resuming sponsored search campaigns when website recovery is detected are performed by a sponsored search agent function which is communicably linked to send pause commands or resume commands to multiple advertising networks.

12. The method as recited in claim 11, where the monitoring agent function comprises multiple monitoring agent functions each remotely located on different internet backbones and where each of the multiple monitoring agent's originating connection initiating an HTTP connection with the web site's server is made from the remote location and where each sends a web site outage notification to the search campaign management tool when detecting an outage.

13. The method as recited in claim 12, where the search campaign management tool has control logic initiating a pause phase function pausing sponsored search campaigns when website outage notifications are received by multiple monitoring agent functions.

14. The method as recited in claim 13, where the search campaign management tool and the monitoring agent performs a content check of a response back from the web sites server.
